(19) United States
(12) Patent Application Publication
(10) Pub. No.: US 2002/0167882 A1
(43) Pub. Date: Nov. 14, 2002

(54) Method and apparatus for ejecting a removable data storage cartridge

(76) Inventor: Paul C. Kunz, Ogden, UT (US)

Correspondence Address: Jerry W. Mills, Esq., Baker Botts L.L.P., Suite 600, 2001 Ross Avenue, Dallas, TX, 75201-2980, US

(21) Appl. No.: 09/854,354

(22) Filed: May 11, 2001

(51) Int. Cl. G11B 33/02; G11B 5/016; G11B 17/04

(52) U.S. Cl. 369/77.2; 360/99.02; 360/99.06

(57) ABSTRACT

A data storage cartridge (14) can be removably inserted into a drive (13), so that respective connectors (52, 67) move into engagement. Two pawls (81, 82) are biased by a spring (119), and engage the cartridge to releasably lock the cartridge in its inserted position. In order to remove the cartridge from the drive, an eject mechanism is actuated, and includes a motorized drive mechanism (221) that moves an eject member (171). The eject member disengages the pawls from the cartridge, effects sufficient movement of the cartridge so as to disengage the connectors, and positions the pawls so that they will properly engage the next cartridge inserted into the drive.

### TECHNICAL FIELD OF THE INVENTION

This invention relates in general to a data storage cartridge that can be removably inserted into a drive and, more particularly, to a method and apparatus for effecting ejection of the cartridge from the drive.

### BACKGROUND OF THE INVENTION

Computer technology has evolved very rapidly over the past 25 years. One aspect of this evolution has been a progressively increasing demand for progressively more storage capacity in removable data storage cartridges. For example, floppy disks capable of storing approximately 360 KB of data gave way to floppy disks capable of storing approximately 720 KB, which in turn gave way to floppy disks capable of storing approximately 1.44 MB of data.

Thereafter, removable data storage cartridges with still higher capacities became commercially available, for example in the form of cartridges available under the tradename ZIP from Iomega Corporation of Roy, Utah, which is the assignee of the present application. ZIP cartridges provided data storage capacities on the order of 100 MB to 250 MB. Still another significant increase in storage capacity was subsequently realized when Iomega introduced removable cartridges under the tradename JAZ, which have storage capacities on the order of 1 GB to 2 GB. Nevertheless, the demand for still greater storage capacities in removable cartridges continues to progressively increase, such there is a current need for cartridges capable of storing 5 GB to 20 GB, or even more.

Existing removable cartridges of the type discussed above tend to be relatively small and lightweight, and tend to consist primarily of a housing with a magnetic disk rotatably supported therein. The drive which receives the cartridge includes a head cooperable with the disk in the cartridge. Further, the drive typically includes some form of eject mechanism for facilitating removal of the cartridge. While these existing eject mechanisms have been generally adequate for their intended purposes, they have not been satisfactory in all respects, and are more suitable for preexisting cartridges than the newest generation of cartridges.

In this regard, next-generation cartridges which are currently in development will be more complex than preexisting cartridges, and will be somewhat larger and heavier. They will include a sealed housing containing not only a rotable storage medium in the form of a hard disk, but also a motor for rotating the disk, at least one read/write head, and a mechanism for effecting movement of the read/write head. Connectors on the cartridge and drive will be releasably engaged in order to electrically couple a number of electrical signals between the cartridge and drive. Pre-existing cartridges do not use connectors of this type. Given various differences of this type, pre-existing eject mechanisms are not well-suited for use with these next generation cartridges.

### SUMMARY OF THE INVENTION

From the foregoing, it may be appreciated that a need has arisen for a method and apparatus for facilitating ejection from a drive of a removable data storage cartridge, where the drive and the cartridge have cooperating connectors. According to the present invention, a method and apparatus are provided to address this need, and relate to operation of an apparatus which includes a receiving unit having a connector and having a cartridge receiving portion into which a cartridge can be removably inserted to an inserted position. The method and apparatus involve: supporting a locking part for movement between locking and unlocking positions; causing the locking part, when a cartridge is disposed in the cartridge receiving portion, to engage the cartridge in the locking position thereof so as to resist cartridge removal from a position in which a connector of the cartridge is engaged with the connector of the receiving unit for the purpose of electrically coupling the receiving unit to an information storage section of the cartridge; resisting movement of the locking part away from the locking position with a retaining portion when a cartridge is disposed in the cartridge receiving portion and is engaged with the locking part; supporting an eject member for movement between a retracted position and an eject position; causing the eject member to move the locking member away from the locking position toward the unlocking position during movement of the eject member from the retracted position to the eject position; causing the eject member, when a cartridge is disposed in the cartridge receiving portion, to engage and move the cartridge away from its insertion position as the eject member moves from the retracted position to the eject position, in a manner effecting disengagement of the connector of the receiving unit from a connector of the cartridge; and responding to the occurrence of a predetermined event by causing a drive portion to effect movement of the eject member from the retracted position to the eject position.

### BRIEF DESCRIPTION OF THE DRAWINGS

FIG. 1 is a diagrammatic perspective view showing an information storage device which embodies the present invention;

FIG. 2 is a diagrammatic perspective view of an interface module which is a component of the information storage device of FIG. 1;

FIG. 3 is a diagrammatic perspective view of a drive module which is a component of the information storage device of FIG. 1;

FIG. 4 is a diagrammatic side view of the drive module of FIG. 3;

FIG. 5 is a diagrammatic rear view of the drive module of FIG. 3;

FIG. 6 is a diagrammatic top view of the drive module of FIG. 3;

FIG. 7 is a diagrammatic perspective view of a cartridge which is a component of the information storage device of FIG. 1;

FIG. 8 is a diagrammatic fragmentary front view of the drive module of FIG. 3, with certain structure omitted for clarity, including a front portion of a housing thereof;

FIG. 9 is a diagrammatic perspective view showing a back and a side of a pawl which is a component of the drive module of FIG. 3;

FIG. 10 is a diagrammatic perspective view showing a front and a side of the pawl of FIG. 9;

FIG. 11 is a diagrammatic perspective view showing front and top sides of an eject member which is a component of the drive module of FIG. 3;

FIG. 12 is a diagrammatic perspective view of the eject member of FIG. 11, showing bottom and front sides thereof;

FIG. 13 is a diagrammatic exploded perspective view of the portion of the drive module which is depicted in FIG. 8;

FIG. 14 is a diagrammatic fragmentary front view similar to FIG. 8, but showing the cartridge of FIG. 7 inserted part way into the drive module;

FIG. 15 is a diagrammatic fragmentary front view of the drive module and cartridge which is similar to FIG. 14, except that the cartridge has been fully inserted, various movable parts of the drive module are in different operational positions, a front portion of the housing of the cartridge has been removed, and certain circuitry and information storage structure provided within the cartridge have been omitted for clarity;

FIG. 16 is a diagrammatic fragmentary front view of an alternative embodiment of the drive module of FIG. 3, which is similar to a portion of FIG. 8 depicted in an enlarged scale, but showing a switch which is not present in the embodiment of FIG. 8;

FIG. 17 is a diagrammatic fragmentary perspective rear view of a portion of an alternative embodiment of the drive module of FIG. 3; and

FIG. 18 is a diagrammatic perspective view showing rear and bottom sides of an eject member which is an alternative embodiment of the eject member shown in FIGS. 11 and 12, and which is a component of the drive module shown in FIG. 17.

### DETAILED DESCRIPTION OF THE INVENTION

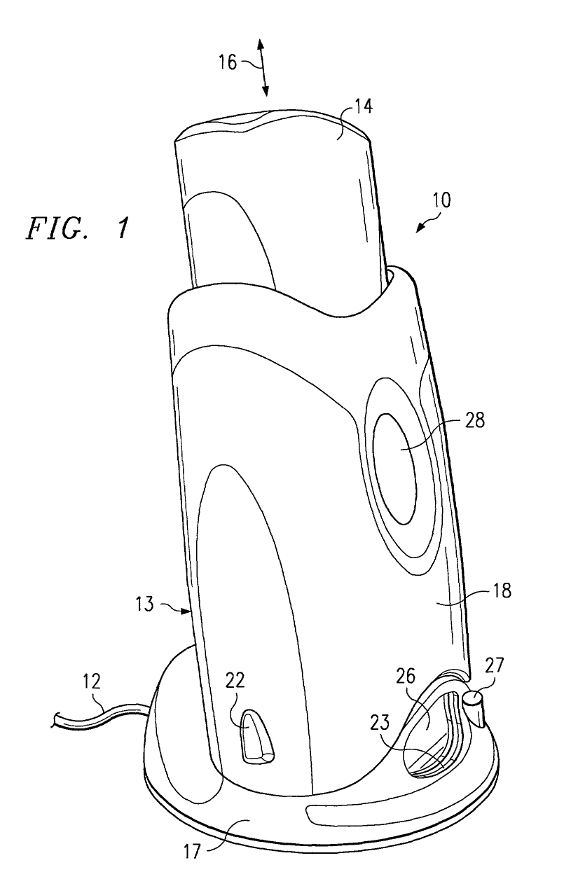

FIG. 1 is a diagrammatic perspective view showing an information storage device 10 which embodies the present invention, and which can be coupled by a cable 12 to a host computer system that is not illustrated. The information storage device 10 includes a receiving unit or cradle 13, and includes an information storage cartridge 14 which is removably inserted into the cradle 13. The cartridge 14 is inserted into and removed from the cradle 13 in directions which are almost vertical, as indicated by a double-headed arrow 16.

The cartridge 14 has a housing, and includes within the housing a not-illustrated information storage media, which in the disclosed embodiment is a rotatable hard disk of a known type. The cartridge 14 also includes within the housing some not-illustrated structure and circuitry that facilitates reading and writing of information from and to the hard disk, including a spin motor for effecting rotation of the disk, a read/write head supported for movement adjacent a surface of the disk, and circuitry coupled to the read/write head. A detailed comprehension of these internal components of the cartridge is not needed in order to understand the present invention, and they are therefore not illustrated and described here in detail.

The cradle 13 includes a base or interface module 17 and a drive module 18, which are physically separate modules that are releasably coupled to each other in a manner described in more detail later. Two manually operable release buttons 22 are provided on opposite sides of the drive module 18, although only one of these two buttons 22 is visible in FIG. 1. When the two release buttons 22 are simultaneously manually pressed, the detachable coupling between the drive module 18 and the interface module 17 is released, so that they can be separated.

The interface module 17 has a window 23 provided through a front wall portion thereof. A liquid crystal display (LCD) 26 is provided on the drive module 18, and is visible through the window 23 of the interface module 17 when the two modules are releasably coupled to each other. A manually operable eject button 27 is provided on the interface module 17. When the eject button 27 is manually pressed downwardly, the interface module 17 sends the drive module 18 an electrical signal which causes the drive module 18 to release a locking mechanism which holds the cartridge in place, and to then effect a partial ejection of the cartridge 14, in a manner described in more detail later.

The drive module 18 has an opening through a front wall thereof, in which is mounted a magnifying lens 28. When the cartridge 14 is removably inserted in the cradle 13, a label on the cartridge can be viewed through the lens 28.

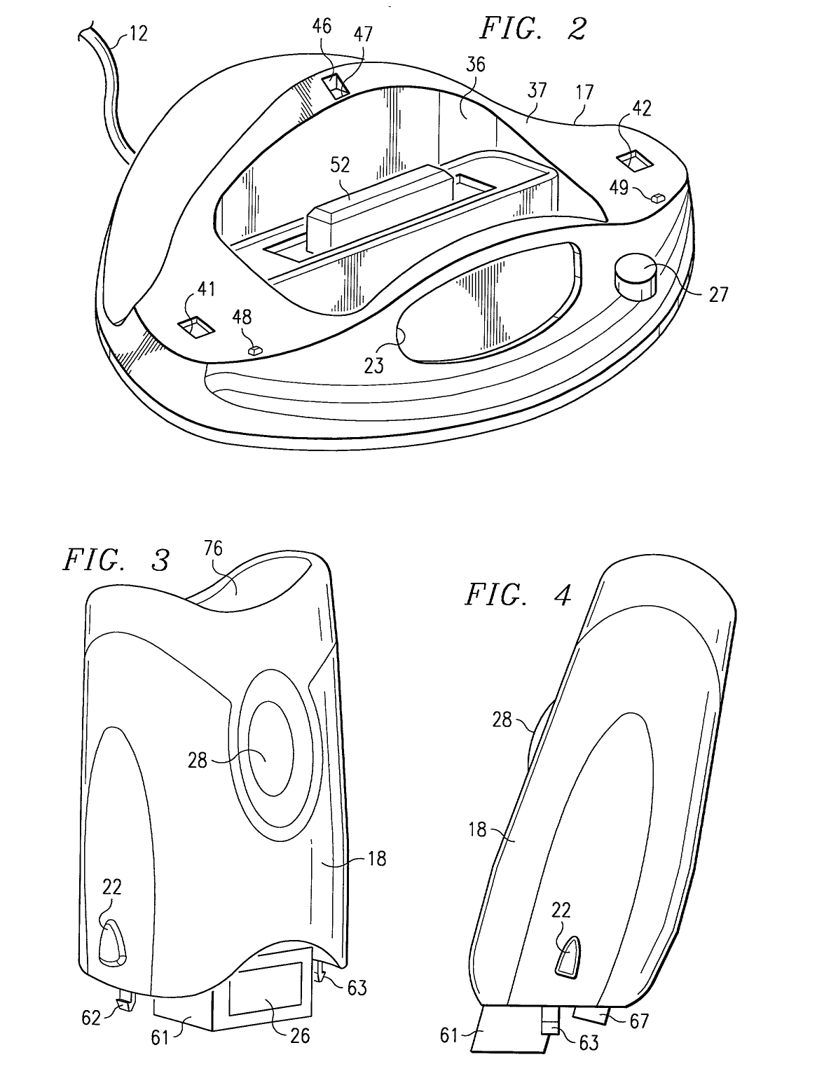

FIG. 2 is a diagrammatic perspective view of the interface module 17 by itself. The interface module 17 has a housing with a top surface 37, and has a recess 36 which opens vertically downwardly into the interface module from the top surface 37 thereof. Two smaller recesses 41 and 42 are provided on opposite sides of the recess 36, and are used to facilitate the detachable coupling of the interface module 17 to the drive module 18, in a manner described later. Immediately behind the recess 36, the top surface 37 has a further recess 46, which has therein an upwardly facing bottom surface 47. The top surface 37 of the housing also has two bosses 48 and 49 disposed on opposite sides of the recess 36, at locations spaced forwardly from the recesses 41 and 42.

A connector 52 is provided within the recess 36, at a location spaced rearwardly from the front wall portion that has therein the window 23. The interface module 17 has circuitry therein which is coupled to the connector 52 and which is responsive to operation of the eject button 27. However, details of the circuitry within the interface module 17 are not needed in order to understand the present invention, and the circuitry is therefore not illustrated and described in detail.

FIG. 3 is a diagrammatic perspective view of the drive module 18 by itself. In addition to the structure of the drive module 18 which has already been described above, it can be seen in FIG. 3 that the drive module 18 has a projection 61 which extends downwardly beyond the bottom of the housing of the drive module 18. The projection 61 has the LCD display 26 mounted on a front side thereof.

The drive module 18 has two pawls 62 and 63 on opposite sides of the projection 61. The two pawls 62 and 63 are each supported for limited movement toward and away from the projection 61, and are each biased to move in a direction away from the projection 61 by a respective spring which is not illustrated. The two release buttons 22 on opposite sides of the drive module 18 are each operatively coupled to a respective one of the pawls 62-63. When the two release buttons 22 are simultaneously manually pressed, they each effect movement of a respective one of the pawls 62-63 in a direction inwardly toward the projection 61, against the urging of the springs that bias the pawls outwardly.

FIG. 4 is a diagrammatic side view of the drive module 18. FIG. 4 shows a connector 67 which extends downwardly beyond the housing of the drive module 18, at a location spaced rearwardly from the projection 61. As evident from FIG. 4, the connector 67 does not extend downwardly as far as the projection 61.

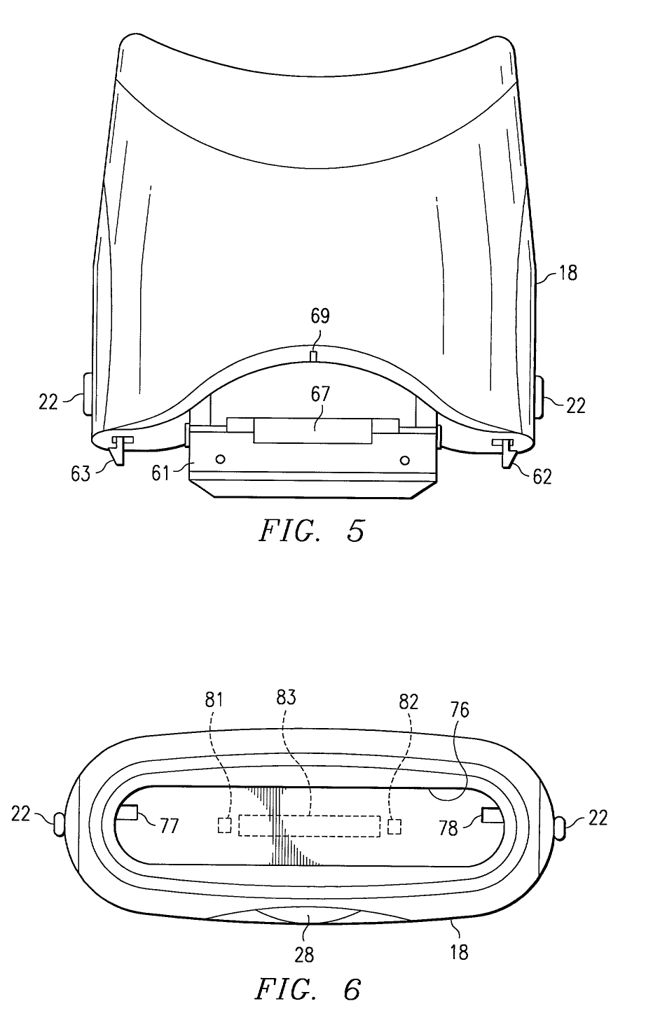

FIG. 5 is a diagrammatic rear view of the drive module 18. The release buttons 22 on opposite sides of the drive module 18 are both clearly visible in FIG. 5. Further, FIG. 5 shows that the housing of the drive module 18 has a downward projection 69 on the rear side of its bottom surface.

When the drive module 18 is to be releasably coupled to the interface module 17, the projection 61 on the drive module 18 is inserted downwardly into the recess 36 (FIG. 2) in the interface module 17, in the region between the connector 52 and the front wall portion with the window 23. The projection 61 cooperates with surfaces in the recess 36 in order to help guide the connector 67 on the drive module 18 into alignment with and then engagement with the connector 52 on the interface module 17.

As the drive module 18 continues to be moved downwardly relative to the interface module 17, and after the connectors 67 and 56 have established electrical contact, the downward projection 69 (FIG. 5) on the drive module 18 engages the bottom surface 47 of the small recess 46 in the interface module 17. Meanwhile, the bosses 48 and 49 on the interface module 17 engage respective locations on the underside of the housing of the drive module 18. The engagement of the bosses 48-49 with the underside of the housing of the drive module 18, in conjunction with the engagement of the projection 69 with the surface 47, establishes three points of contact which define and maintain a proper orientation of the drive module 18 relative to the interface module 17.

As the drive module 18 is being moved downwardly into engagement with the interface module 17, the pawls 62 and 63 respectively enter the recesses 41 and 42, and are each temporarily urged in an inward direction due to their engagement with the edges of the recesses 41-42 during the insertion movement. As the drive module 18 reaches its final position, the pawls 62-63 reach a position where they can move outwardly under the resilient urging of the not-illustrated springs, so that they releasably lockingly engage the recesses 41-42 in a manner that releasably couples the drive module 18 to the interface module 17.

In order to subsequently release the drive module 18 from the interface module 17, the two release buttons 22 are simultaneously manually pressed in order to move the pawls 62 and 63 inwardly, thereby releasing the locking engagement between the pawls 62-63 and the recesses 4142. This in turn permits the drive module 18 to be lifted approximately vertically upwardly out of engagement with the interface module 17.

FIG. 6 is a diagrammatic top view of the drive module 18, looking down into a vertical recess 76 that can removably receive the cartridge 14 (FIG. 1). On opposite sides of the recess 76 are two guide rails 77 and 78, which extend approximately vertically down into the recess 76 lengthwise thereof, and which project inwardly into the recess 76 from opposite sides thereof. The guide rails 77-78 are each slightly offset from the center of the recess 79 in a direction normal to an imaginary plane extending between the guide rails.

At the bottom of the recess 76 is a connector 73, which is shown diagrammatically in broken lines in FIG. 6. On opposite sides of the connector 83 are two movably supported latching pawls 81 and 82. The pawls 81 and 82 are each shown diagrammatically by broken lines in FIG. 6, and are each supported for limited movement toward and away from the connector 83. The pawls 81-82 and the connector 83 are discussed in more detail later.

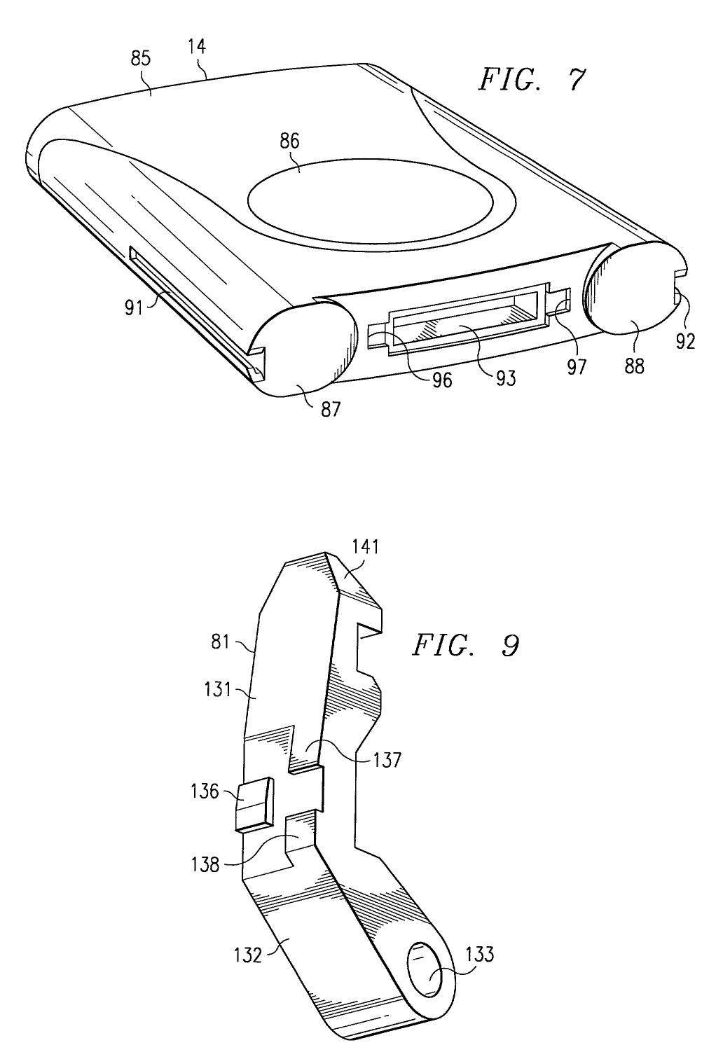

FIG. 7 is a diagrammatic perspective view of the cartridge 14 by itself. The cartridge 14 has on one side of its housing 85 a label 86, which carries indicia that is not shown in the drawings. When the cartridge 14 is removably inserted into the cradle 13, as shown in FIG. 1, the indicia on the label 86 is visible through the magnifying lens 28. The cartridge housing 85 has at one end two spaced outward projections 87 and 88. The housing 85 has on opposite sides thereof two elongate grooves 91 and 92. The grooves 91 and 92 each extend approximately half the length of the cartridge 14, beginning from the end surface of a respective one of the projections 87 and 88. As evident in FIG. 7, the sidewalls of the grooves 91-92 are flared slightly at the ends of the grooves adjacent to the projections 87-88. Also, the grooves 91 and 92 are each offset slightly with respect to the center of the cartridge 14, in a direction normal to an imaginary plane extending between the grooves 91-92.

Between the projections 87 and 88, in an end surface of the cartridge 14, is a connector 93. On opposite sides of the connector 83, the housing 85 of the cartridge 14 has two openings or recesses 96 and 97.

With reference to FIGS. 6 and 7, the guide rails 77-78 and the slots 91-92 ensure that there is only a single orientation in which the cartridge 14 can be inserted into the recess 76. In particular, since the grooves 91-92 only extend approximately half the length of the cartridge 14, it is not possible to insert the wrong end of the cartridge 14 very far into the recess 76, because the guide rails 77-78 will engage an end surface of the cartridge 14 and thereby prevent further insertion of the cartridge 14 with that orientation.

Moreover, even when the correct end of the cartridge 14 is introduced into the recess 76, the cartridge 14 must be oriented so that the label 86 on the cartridge 14 is facing in the same direction as the lens 28 on the drive module 18. This is because, as discussed above, the guide rails 77-78 are offset slightly with respect to a center of the recess 76, and the grooves 91-92 are offset slightly with respect to a center of the cartridge 14. If the label 86 is facing in a direction opposite from the direction in which the lens 28 is facing, there will be a mechanical interference between the guide rails 77-78 and the end surfaces of the projections 87-88, which will occur after the cartridge has been only partially inserted, so as to prevent any further insertion movement of the cartridge 14 into the recess 76.

When the cartridge 14 is inserted into the recess 76 with the proper orientation, the flared side surfaces at the ends of the grooves 91-92 help guide the upper end of each guide rail 77-78 into the associated groove 91 or 92. Thereafter, the guide rails 77-78 and the grooves 91-92 cooperate in a manner which serves two functions.

First, their cooperation ensures that the connectors 93 and 83 will be accurately aligned as they move into engagement with each other. Second, their cooperation has the effect of positioning the cartridge 14 within the recess 76 in a manner so that the exterior surfaces of the cartridge 14 are spaced from and do not rub against the internal surfaces of the recess 76, except to the extent that surfaces on the guide rails 77-78 engage surfaces in the grooves 91-92. Thus, even after the cartridge 14 has been inserted into and removed from the drive module 18 many times, most of the exterior surfaces of the cartridge 14 will still look very new, rather than being highly scuffed.

As the cartridge 14 is being removably inserted into the recess 76, and as the connectors 93 and 83 move into mating engagement, the pawls 81 and 82 of the drive module 18 respectively move into the recesses 96 and 97, and are temporarily deflected inwardly by edges of the recesses as they enter the recesses. Then, as the connectors 83 and 93 reach proper mating engagement, the pawls 81 and 82 reach positions where they move outwardly so that locking edges thereon engage edges of the recesses 96-97 in a manner which prevents manual withdrawal of the cartridge 14 from the drive module 18.

In order to remove the cartridge from the drive module 18 in a normal manner, an operator manually presses the eject button 27 on the interface module 17 (FIGS. 1 and 2). The not-illustrated circuitry within the interface module 17 will respond to actuation of the eject button 27 by transmitting an electrical signal through the connectors 52 and 67 to the drive module 18. The drive module 18 has a release mechanism which then moves the pawls 81 and 82 inwardly toward the connector 83, until they are released from latching engagement with the recesses 96 and 97. The release mechanism them moves the cartridge 14 upwardly a sufficient distance relative to the drive module 18 so as to effect disengagement of the connector 93 from the connector 83. This release mechanism is configured to alternatively permit a manually-operated release that moves the pawls and separates the connectors, for example in a situation where the motor which drives the release mechanism does not currently have power, or experiences some type of failure. This release mechanism within the drive module 18 will be described in more detail later.

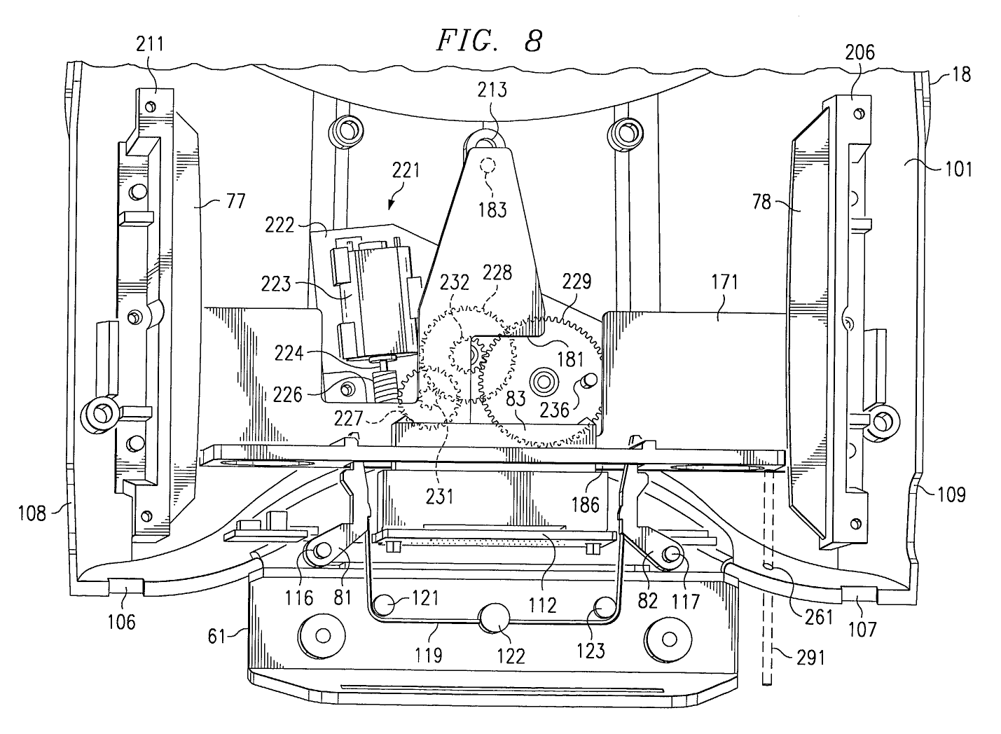

FIG. 8 is a diagrammatic fragmentary front view of the drive module 18 with a front portion of the housing thereof removed, so that only a rear portion 101 of the drive module housing is visible. The drive module 18 is shown in FIG. 8 with no cartridge 14 inserted therein. For clarity, and with reference to FIGS. 3 and 4, FIG. 8 does not show the pawls 62-63, the release buttons 22 that operate them, or other associated structure. However, it will be noted that the housing portion 101 has recesses 106 and 107 through which the pawls 62-63 project out of the housing, and also has recesses 108 and 109 through which the release buttons 22 project out of the housing.

The connector 83 of the drive module 18, which can electrically couple the drive module 18 to a cartridge 14, is shown in approximately the center of FIG. 8. It is fixedly supported on a circuit board 112, which in turn is fixedly secured on the housing portion 101. The connector 83 thus does not move relative to the housing portion 101. The pawls 81 and 82 are shown on opposite sides of the connector 83, and each pawl has one end pivotedly supported on a respective pivot pin 116 or 117, the pivot pins 116-117 each being provided on the housing portion 101.

A U-shaped wire spring 119 has two spaced legs coupled by a bight, the bight being supported by three posts 121-123 which are each an integral part of the housing portion 101. The post 122 has a transverse slot in the side thereof facing the connector 83, and this slot receives the center of the bight of the spring. The posts 121 and 123 are each provided at an inside corner of the spring, between the bight and a respective one the legs. Each of the legs of the spring 119 engages a respective one of the pawls 81 and 82 on a side thereof nearest the connector 83, and resiliently urges the associated pawl to pivot in a direction away from the connector 83.

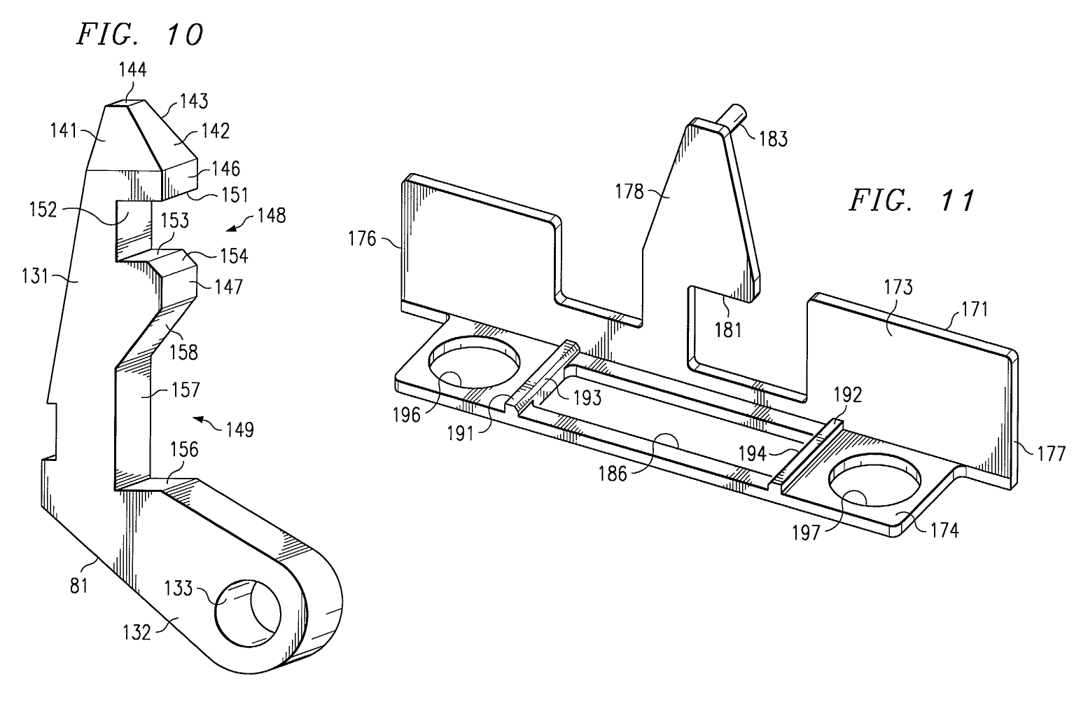

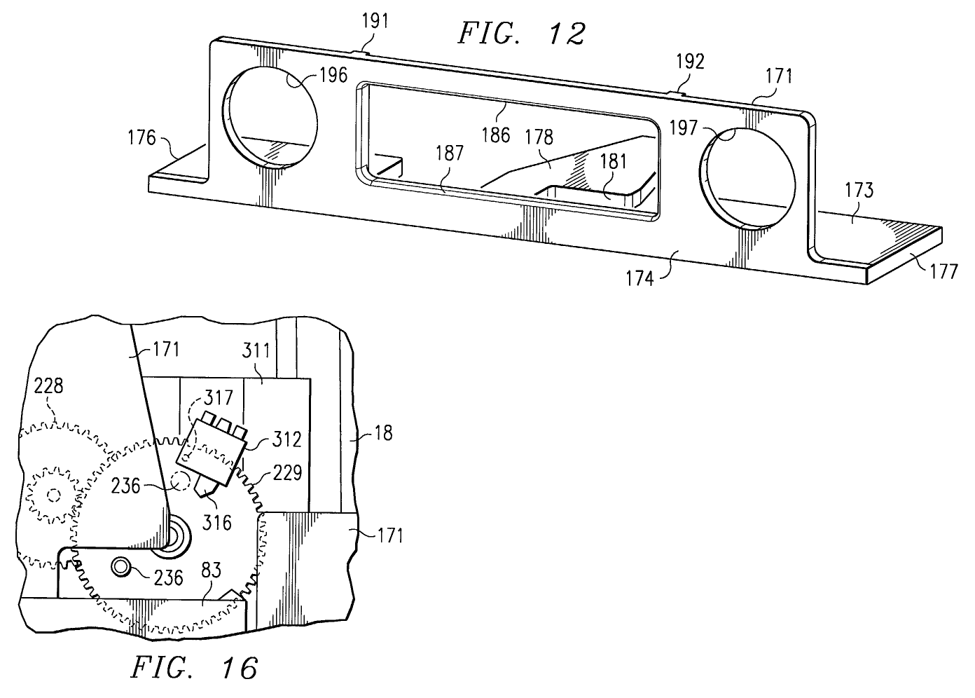

In the disclosed embodiment, the pawls 81 and 82 are mirror images of each other, but they could alternatively be identical. Therefore, only the pawl 81 is illustrated and described in detail. More specifically, FIG. 10 is a diagrammatic perspective view showing a front and side of the pawl 81, and FIG. 9 is a further diagrammatic perspective view showing a back and side of the pawl 81. The pawl 81 has upper and lower portions 131 and 132, which extend at an obtuse angle to each other. A cylindrical opening 133 extends transversely through the pawl 81 at the lower end of the portion 132, and pivotally receives the pivot pin 116 (FIG. 8). On the back side of the upper portion 131 are three bosses 136-138, which are arranged so that a slot is effectively defined between the boss 136 and the bosses 137-138. An end of the wire spring 119 is received in this slot, and the bosses 136-138 maintain the end of the spring in proper operational engagement with the pawl 81.

The upper end of the pawl 81 is an irregular pyramid-shaped frustrum, with an upwardly tapering cross section, and includes three inclined surfaces 141-143 that taper to an approximately square top surface 144. The inclined surfaces 141-143 help guide the upper end of the pawl into a respective one of the recesses 96-97 (FIG. 7) in the cartridge 14. The front surface of the upper portion 131 of the pawl 81 includes two spaced surface portions 146 and 147. A recess 148 is provided between the surface portions 146 and 147, and a further recess 149 is provided on an opposite side of the surface portion 147 from the recess 146.

The recess 148 has a downwardly facing surface portion 151, a forwardly facing surface portion 152, and an upwardly facing surface portion 153. The surface portion 152 is approximately perpendicular to each of the surface portions 151 and 153. A further surface portion 154 is provided between the surface portions 153 and 147, and is angled to extend at approximately 45° with respect to each of the surface portions 153 and 147.

The recess 149 includes at its lower end an upwardly facing stop surface 156. It will be noted that the stop surface 156 is disposed approximately at the intersection of the upper and lower portions 131 and 132 of the pawl 81. A forwardly facing surface portion 157 extends upwardly within the recess 149 from the stop surface 156, approximately perpendicular to the stop surface 156. An inclined surface portion 158 extends between the surface portions 157 and 147, at an angle of approximately 45° with respect to each. The surface portions 142 and 146 together serve as an upper cam surface, and the surface portions 147, 158 and 157 together serve as a lower cam surface. The recess 148 is disposed between these two cam surfaces, and the surface portion 154 provides a transition between the recess 148 and the lower cam surface, for a purpose discussed later.

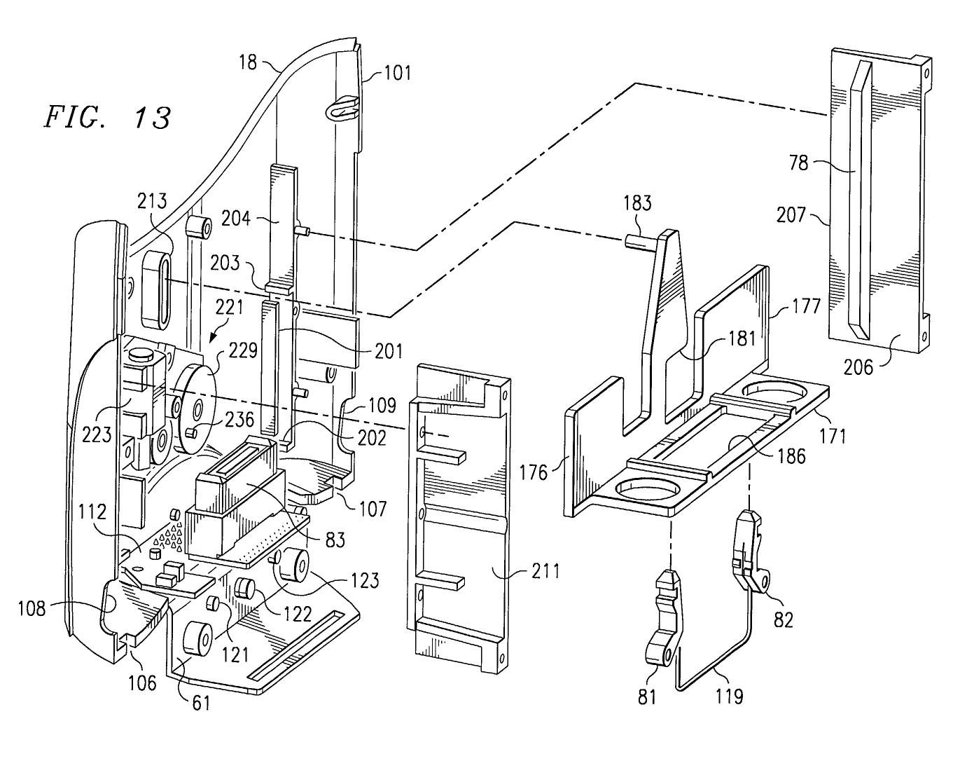

Referring again to FIG. 8, a lift or eject member 171 is supported for reciprocal vertical movement within the drive member 18. The manner in which the eject member 171 is movably supported will be described in more detail below, but first the eject member itself is described in detail, with reference to FIGS. 11 and 12.

More specifically, FIG. 11 is a diagrammatic perspective view of the eject member 171, showing the front and top sides thereof, and FIG. 12 is a further diagrammatic perspective view of the eject member 171, showing the bottom and front sides thereof. The eject member 171 has a vertical portion 173 and a horizontal portion 174, which are each approximately platelike. The horizontal portion 174 extends forwardly from the lower end of the vertical portion 173, approximately perpendicular thereto.

The vertical portion 173 has vertically extending edge portions 176 and 177 on opposite sides thereof, which facilitate support of the eject member 171 for vertical sliding movement within the drive module 18, in a manner described later. A central portion 178 of the vertical portion 173 has a downwardly facing surface 181, which is substantially centered between the edge portions 176 and 177, and which serves a purpose described later. At the upper end of the central portion 178 is a rearwardly extending guide pin 183, which also facilitates the vertical sliding movement of the eject member 171 within the drive module 18, in a manner discussed later.

Turning to the horizontal portion 174 of the eject member 171, a central opening 186 of approximately rectangular shape extends vertically through the horizontal portion 174. As best seen in FIG. 12, a bevel 187 extends completely around the opening 186 on the lower side of the horizontal portion 174. The bevel 187 forms an angle of approximately 45° with respect to the bottom surface of the horizontal portion 174, and also with respect to the vertically extending edge surfaces of the central opening 186.

Two ridges 191 and 192 project upwardly from the upper side of the horizontal portion 174, adjacent opposite ends of the opening 186. The ridges 191-192 extend parallel to each other in a front to rear direction, and are positioned so that each has a side which faces the other thereof and which is approximately flush with the associated end surface of the opening 186. The ridges 191 and 192 each have a 45° bevel surface 193 or 194 between the top thereof and the side thereof which faces the other ridge. The ridges 191-192 increase the effective thickness of the horizontal portion 174 at each of the ends of the central opening 186, for a purpose discussed later. The two ends of the central opening 186, including surface portions on the ridges 191-192 and also on the horizontal portion 174, serve as respective cam followers, in a manner discussed later. Two circular openings 196 and 197 extend vertically through the horizontal portion 174, on opposite sides of the central opening 186.

In order to explain how the eject member 171 is slidably supported within the drive module 18, reference is made to FIG. 8, and also to FIG. 13. FIG. 13 is a diagrammatic exploded perspective view of the portion of the drive module 18 which is depicted in FIG. 8. FIG. 13 shows that the housing portion 101 has on one side thereof an elongate surface 201 that extends vertically and faces forwardedly, an upwardly facing surface 202 near the lower end of surface 201, and a downwardly facing surface 203 near the upper end of surface 201. A surface 204 extends upwardly along the surface 201 perpendicular thereto, and faces sidewardly.

A side member 206, which has the guide rail 78 thereon, is secured by not-illustrated screws to the housing portion 101, in a position so that a rearwardly facing surface 207 on the side member 206 is spaced slightly from and faces the forwardly facing surface 201 on the housing portion 101. As a result, the surfaces 201 and 207 effectively define opposite sides of a slot, the surface 204 effectively defines the bottom of the slot, and the surfaces 202 and 203 effectively define ends of the slot. The outer edge 177 of the eject member 171 is vertically slidably received within this slot.

The end surfaces 202 and 203 are capable of engaging the eject member 171 to limit its vertical movement, but there is other structure which limits upward and downward movement of the eject member 171, such that it never actually engages the surfaces 202 and 203 during normal operation. The opposite outer edge portion 176 of the eject member 171 is slidably supported in a similar slot defined by structure which is a mirror image of the structure that has just been described, including a further side member 211 which is a mirror image of the side member 206, and which has thereon the guide rail 77. The housing portion 101 has a vertically extending slot 213 which slidably receives the guide pin 183 of the eject member 171.

As best seen in FIG. 8, the connector 83 projects through the central opening 186 provided in the horizontal portion of the eject member 177, without touching the eject member 171. The upper portions 131 of the two locking pawls 81 and 82 each extend through the central opening 186, and the lower cam surfaces on the pawls can each slidably engage one of the ends of the central opening 186, which as mentioned above can function as cam followers. The cooperation between the pawls and the cam followers on the eject member 171 will be described in more detail later.

The drive module 18 includes a motorized drive mechanism 221, which is best seen in FIG. 8. The drive mechanism 221 includes a vertical support plate 222, which is fixedly secured by not-illustrated screws to the housing portion 101. The support plate 222 has an electric motor 223 mounted thereon, which in the disclosed embodiment is a direct current brush motor. The motor 223 has a rotatable shaft 224, and a worm gear 226 is mounted on the shaft 224.

Three spur gears 227, 228 and 229 are rotatably supported on respective pivot pins provided at spaced locations on the support plate 222. The worm gear 226 drivingly engages teeth provided along the outer periphery of the gear 227. Integral with the gear 227 is a concentric further spur gear 231 of substantially smaller diameter, which drivingly engages teeth provided on the outer periphery of the gear 228. Still another spur gear 232 is concentric to and integral with the gear 228, but of substantially smaller diameter. The spur gear 232 engages teeth provided along the outer periphery of the gear 229, which is referred to herein as a crank gear.

The crank gear 229 has, at a location eccentric to its pivot, a forwardly projecting actuating pin 236. When the drive mechanism 221 is idle, the motor 223 is off and the crank gear 229 is in the angular position shown in FIG. 8. When the drive mechanism 221 is actuated, the motor 223 is energized in a manner which causes the crank gear 229 to rotate 360° in a clockwise direction in FIG. 8, so that the actuating pin 236 begins from and ends back up in the position shown in FIG. 8.

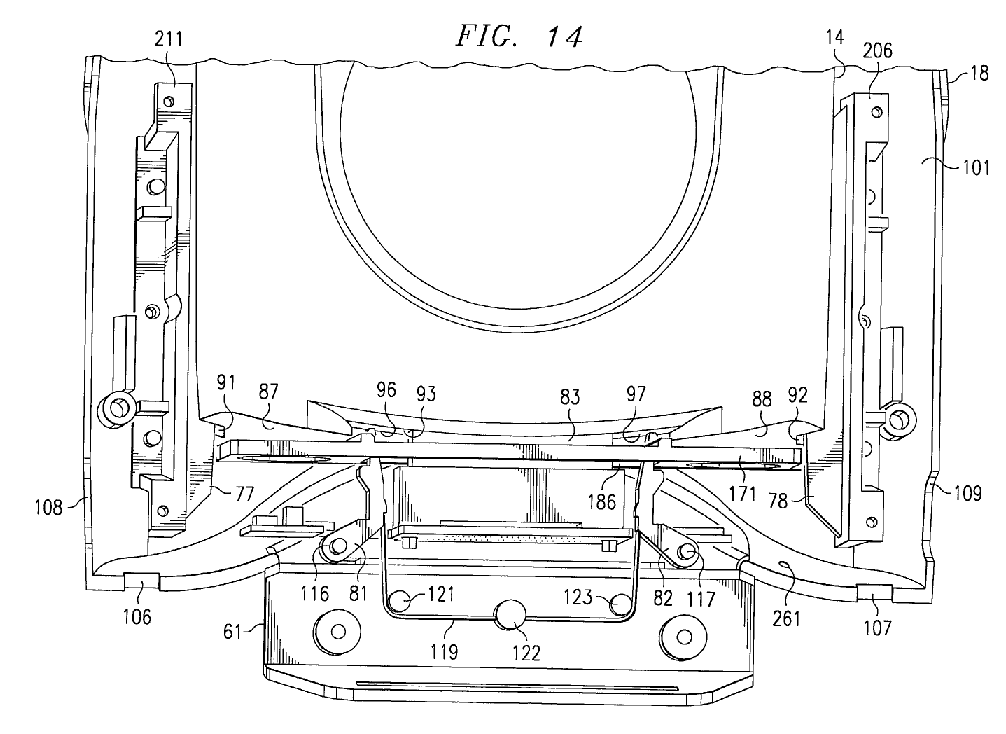

FIG. 14 is a diagrammatic fragmentary front view similar to FIG. 8, showing the cartridge 14 inserted part way into the drive module 18. The movable elements within the drive module 18 are all in the same operational positions that are shown in FIG. 8. The cartridge 14 has been inserted to a point where the projections 87 and 88 on the lower end thereof are engaging the top surface of the horizontal portion of the eject member 171.

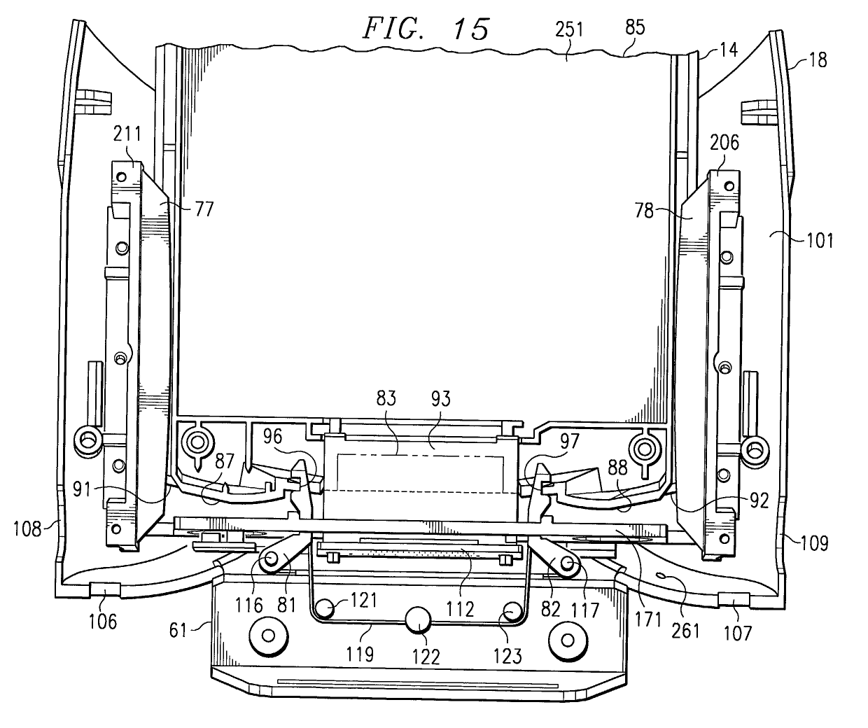

FIG. 15 is a diagrammatic fragmentary front view which is similar to FIG. 14, except that the cartridge 14 has been fully inserted, and various movable parts of the drive module 18 are in different operational positions. As one aspect of this, it will be noted that that the connector 83 of the drive module 18 is fully engaged with the connector 93 of the cartridge 14. Also, a front portion of the housing 85 of the cartridge 14 has been removed, so that only that a back portion 251 of the cartridge housing 85 is visible in FIG. 15. To avoid unnecessary complexity in FIG. 15, the circuitry and information storage structure provided within the cartridge 14 have been omitted.

With reference to FIG. 15, it will be noted that the housing portion 101 of the drive module 18 has a small opening 261 provided vertically therethrough between the downward projection 61 and the recess 107. This opening can be used to manually operate of the release mechanism in the drive module, in a manner described in more detail later.

A brief discussion will now be provided of the operation of certain structure described above. In this regard, and as discussed above, the eject member 171 is capable of reciprocal vertical sliding movement within the drive module 18. As the eject member 171 moves vertically, the cam followers at the opposite ends of the central opening 186 can slide along the above-mentioned lower cam surfaces on the upper portions 131 (FIG. 10) of the pawls 81 and 82. FIG. 15 shows the lowest position of the eject member 171, in which the bottom surface of the eject member 171 engages the stop surfaces 156 (FIG. 10) on the pawls 81 and 82. The stop surfaces 156 prevent downward movement of the eject member 171 past the position shown in FIG. 15.

The uppermost position of the eject member 171 is shown in FIGS. 8 and 14, where the cam followers at opposite ends of the central opening 186 each engage the recess 148 in a respective one of the pawls 81 and 82. The bevel surfaces 193 and 194 (FIG. 11) on the eject member 171 each engage a respective pawl 81-82 at the corner between the surface portions 151 and 146, and portions of the bevel surface 187 each engage the bevel surface 154 on a respective pawl 81-82. This is the position that the eject member 171 will normally be in when no cartridge is inserted, as evident from FIG. 8. The resilience exerted by the spring 119 on the pawls 81-82, in conjunction with the various bevel surfaces on the pawls 81-82 and the eject member 171, cause the cam followers on the eject member 171 to tend to be retained within the recesses 148 in the pawls.

It would theoretically be possible for the eject member 171 to move further upwardly from the position shown in FIG. 8, until the pin 183 thereon engages the upper end of the slot 213, and/or until the upper ends of the edge portions 176-177 engage the surfaces 203. In particular, if an upward force were applied to the eject member 171 while it was in the position of FIG. 8, the bevel surfaces 193-194 on the eject member 171 would pivot the pawls 81-82 inwardly against the urging of the spring 119 as the eject member 171 moved upwardly in response to the applied force. In the disclosed embodiment, however, the actuating pin 236 on the crank gear 229 moves the eject member 171 only up to the position which is shown in FIG. 8, and there is no other structure within the drive module which would move the eject member 171 any higher than the position of FIG. 8 during normal operation.

With reference to FIG. 14, when a cartridge 14 is inserted into the drive module 18 with the proper orientation, the guide rails 77 and 78 slide into the grooves 91 and 92 of the cartridge 14, and the cartridge 14 will reach the partially inserted position shown in FIG. 14, where the projections 87 and 88 on the cartridge each engage the horizontal portion of the eject member 171. In response to the downward manual force which is still being exerted on the cartridge 14, the projections 87 and 88 will urge the eject member 171 to move downwardly. It will be noted that, with the crank gear 229 and the actuating pin 236 stopped in the angular position shown in FIG. 8, the eject member 171 can move downwardly without engaging any portion of the drive mechanism 221, and in particular without contacting the actuating pin 236.

In response to this downward force being manually exerted on the cartridge 14, the portions of the beveled surface 187 at opposite ends of the opening 186, which define parts of the cam followers, cooperate with the angled surface portions 154 (FIG. 10) on the pawls 81 and 82, so as to urge each of the pawls to pivot inwardly against the urging of the spring 119. As this occurs, the cam followers at the ends of the opening 186 slide down onto the surface portions 147 (FIG. 10) of the pawls 81 and 82. This facilitates entry of the upper ends of the pawls 81 and 82 into the recesses 96 and 97 in the cartridge. The inclined surfaces 141-143 (FIG. 10) at the upper ends of the pawls also help guide the upper end of each pawl into a respective recess 96 or 97.

In response to further manual insertion of the cartridge, the cam followers at the ends of the openings 186 in eject member 171 will slide off the surface portions 147 of the pawls 81-82, and then down the inclined surface portions 158 (FIG. 10) toward the surface portions 157. During this movement, the engagement of the upper ends of the pawls 81-82 with the recesses 96-97 in the cartridge 14 will eventually cause the pawls to be held in an inwardly pivoted position, in which the cam followers on the eject member 171 do not engage the surface portions 157 on the pawls 81-82. At this point, the eject member 171 can drop downwardly under the force of gravity until it engages the stop surfaces 156 (FIG. 10) on the pawls 81-82.

Thereafter, further manual insertion of the cartridge 14 results in the connectors 83 and 93 moving into full engagement with each other, which is the operational position shown in FIG. 15. In this position, and as shown in FIG. 15, the edge portions of the recesses 96 and 97 in the cartridge reach a position in which they are aligned with the recesses 148 (FIG. 10) in the pawls 81-82, and the pawls 81 and 82 can then pivot outwardly somewhat under the urging of the spring 119, to the positions which are shown in FIG. 15. In FIG. 15, interior surface portions of the cartridge housing adjacent each of the recesses 96-97 engage the surfaces 151 (FIG. 10) of the pawls, thereby preventing upward movement of the cartridge relative to the pawls. The cartridge 14 is now releasably latched within the drive module 18 by the pawls 81 and 82.

It should be noted that the pivot pins 116 and 117 for the pawls 81-82 are each disposed laterally outwardly from the point of engagement between each pawl and the associated edge of a recess 96 or 97. Thus, if the user attempts to manually withdraw the cartridge 14, the upward manual force exerted on the cartridge will tend to urge the pawls 81 and 82 to pivot outwardly, away from the connectors 83 and 93. Pivotal movement in this direction urges the recesses 148 in the pawls into tighter engagement with the housing of the cartridge, thus enhancing the locking engagement between the pawls 81-82 and the cartridge. accordingly, the cartridge 14 is securely held against manual withdrawal once it has been inserted to the position of FIG. 15 and is latched in place there.

In order to remove the cartridge 14 in a normal manner, the user presses the eject button 27 (FIGS. 1 and 2) on the interface module 17, causing circuitry within the interface module 17 to send an electrical signal through the connectors 52 and 67 (FIGS. 2 and 4) to a circuit within the drive module 18. This circuit in the drive module 18 energizes the motor 223 of the drive mechanism 221 in a manner causing the crank gear 229 (FIG. 8) to carry out one full revolution in a clockwise direction, and then stop again in the position shown in FIG. 8.

As the crank gear 229 rotates, the actuating pin 236 thereon initially moves downwardly and to the left in FIG. 8, and thereby moves under the downwardly facing surface 181 on the eject member 171. The eject member 171 and the surface 181 thereon will, of course, be physically lower at this time than the position shown in FIG. 8. As the crank gear 229 continues to rotate, the actuating pin 236 will begin to move upwardly and, due to engagement with the surface 181, will force the eject member 171 to also move upwardly.

As the eject member 171 is moved upwardly, the cam followers at the ends of the central opening 186, including the bevels 193 and 194 (FIG. 11), will engage the inclined surfaces 158 (FIG. 10) on the pawls 81 and 82, and thus force the pawls 81 and 82 to pivot inwardly against the urging of the spring 119. This effects disengagement of each pawl 81-82 from the associated recess 96 or 97 in the cartridge 14. As the eject member 171 continues moving upwardly, it will engage the projections 87 and 88 on the lower end of the cartridge 14, and then the cartridge 14 will be moved upwardly by the eject member 171 as the eject member continues moving upwardly. As the eject member 171 moves the cartridge 14 upwardly in relation to the drive module 18, the pawls 81-82 will exit the recesses 96-97 in the cartridge 14, and the connectors 83 and 93 will be separated from each other.

With reference to FIG. 8, rotation of the crank gear 229 will cause the actuating pin 236 to eventually reach the vertically highest position along its path of travel, in which it has raised the eject member 171 to the position shown in FIG. 8. After that, the actuating pin 236 will move rightwardly and downwardly out of engagement with the surface 181, back to the position which is shown in FIG. 8.

As the pin 236 leaves engagement with the eject member 171, with the eject member 171 in the position shown in FIG. 8, the cam followers at the ends of the central opening 186 in the eject member 171 will each be engaging the recess 148 in a respective one of the pawls 81-82. Because the ridges 91-92 increase the effective thickness or height of the eject member in the region of the cam followers, the cam followers will only be able to partially enter the recesses 148 in the pawls. Consequently, the angled surfaces 154 on the pawls will each be engaging the bevel surface 187 on the eject member, so that the eject member 171 is ready to move out of engagement with the recesses 148 in the pawls in response to the application of a downward force to the eject member.

In this operational position, the combined weight of the eject member 171 and the cartridge 14 supported on it does not generate enough of a downward force to cause the cam followers on the eject member 171 to pivot the pawls 81 and 82 inwardly. Thus, the eject member 171 will tend to remain in the position shown in FIG. 8, where it supports the cartridge in a position with the connectors 83 and 93 disengaged and slightly spaced from each other. The user can then manually lift the cartridge directly out of the drive module 18. Since the connectors 83 and 93 are fully disengaged, and the pawls 81-82 are no longer engaging the cartridge, there is no significant friction or other force tending to retain the cartridge 14 within the drive module 18. Thus, the user can lift the cartridge 14 out of the drive module 18 with one hand, without any need to use the other hand to hold down the cradle 13 while forcibly separating the cartridge 14 from the drive module 18.

When a cartridge 14 has been fully inserted to the position shown in FIG. 15, and as was discussed above in association with FIG. 15, an attempt by a user to manually withdraw the cartridge from the drive module 18 will not be successful, because it will tend to pivot the pawls 81-82 in a direction which increases the effective locking force. This is why the normal mode of removing the cartridge 14 is to press eject button 27 (FIGS. 12), in order to energize the drive mechanism 221 and permit it to automatically release the pawls 81-82 and then partially eject the cartridge 14, so that the connectors 83 and 93 become separated. However, there may be rare circumstances in which it would be desirable to be able to manually remove the cartridge 14 from the drive module 18 without relying on the drive mechanism 221.

For example, the drive module 18 receives operating power from the interface module 17, and can be detached from the interface module 17. Thus, if the drive module 18 has a cartridge inserted but is not currently coupled to an interface module, the drive mechanism 221 has no electric power, and cannot be used to release and eject the cartridge 14: Another unlikely but possible scenario is that, after extensive use of the drive module 18 over a long period of time, there may be some form of failure within the drive mechanism 221 which prevents it from operating, even when the drive module 18 is supplied with power. In this situation, a user may need to return the drive module 18 to a service center for repair, but would not want to send the cartridge 14 to the service center, particularly where the cartridge 14 included confidential or other sensitive data. For these reasons, the drive module 18 includes provisions for effecting a manual release and ejection of a cartridge in rare or emergency circumstances.

More specifically, and with reference to FIG. 8, an elongate release element 291, which is shown diagrammatically in FIG. 8, can be manually slidably inserted through the manual release opening 261 in the housing of the drive module, until its upper end engages the underside of the eject member 171. By then manually applying an upward force to the release element 191, it will force the eject member 171 to move upwardly from its lowermost position (FIG. 15) to its uppermost position (FIG. 8).

As the eject member 171 carries out this upward movement, it disengages the pawls 81-82 from the cartridge 14 and moves the cartridge 14 upwardly so as to separate the connectors 83 and 93, in a manner identical to that discussed above for movement of the eject member 171 by the drive mechanism 221. It will be noted that, even if the crank gear 229 has stopped in a position other than the normal stop or idle position shown in FIG. 8, the eject member 171 is configured so that it is always capable of upward movement relative to the actuating pin 236. Once the eject member 171 has been manually moved upwardly to the position of FIG. 8 by the release element 291, the release element 291 can be withdrawn from the opening 261, and the cartridge 14 can be manually lifted out of the drive module 18.

FIG. 16 is a diagrammatic fragmentary front view of an alternative embodiment of the drive module of FIG. 3. FIG. 16 is similar to a portion of FIG. 8 depicted in an enlarged scale, and equivalent components are designated with the same reference numerals. The embodiment of FIG. 16 is generally the same as the embodiment of FIG. 8, except for the differences discussed below.

FIG. 16 depicts an additional mounting plate 311, which is fixedly secured to the mounting plate 222 (FIG. 8) for the motor 223 (FIG. 8). A position detect switch 312 of a known type is supported on the mounting plate 311, and has an operating member 316 which is pivotally supported by a pivot pin 317. The operating member 316 can pivot counterclockwise about the pivot pin 317 in FIG. 16, from the advanced position shown in FIG. 16 to a retracted position where it is disposed within the housing of the switch 312. The operating member 316 is resiliently urged toward its advanced position by a not-illustrated spring. As the operating member 316 pivots from the advanced position to the retracted position, the switch is actuated.

The housing of the switch 312 is disposed closely adjacent the peripheral edge of the crank gear 229. In its advanced position, the operating member 316 projects radially inwardly adjacent a side surface of the crank gear 229. The terminals of the switch 312 are electrically coupled to the above-mentioned circuit which controls the motor 223.

The operation of the embodiment of FIG. 16 is generally similar to the operation of the embodiment of FIGS. 1-15, except as follows. More specifically, as the motor 223 rotates the gear 229 in a clockwise direction in FIG. 16, the actuating pin 236 thereon will eventually reach the angular position which is shown in broken lines in FIG. 16. As the actuating pin 236 moves beyond this position, it will engage the operating member 316 and pivot the operating member from its advanced position to its retracted position, thereby actuating the switch 312. The circuit which controls the motor 223 will then know the current angular position of the pin 236, and in particular will know that the pin has just reached the beginning of a range of positions in which, if the gear 229 is stopped with the pin 236 disposed within that range of positions, the pin 236 will not be able to interfere with reciprocal movement of the eject member 171. Consequently, the circuit can turn the motor 223 off as soon as the switch 312 is actuated, or a short predetermined time interval after the switch 312 is actuated, in order to stop the gear 229 in a position in which the pin 236 is within the range of positions where it cannot interfere with movement of the eject member 171.

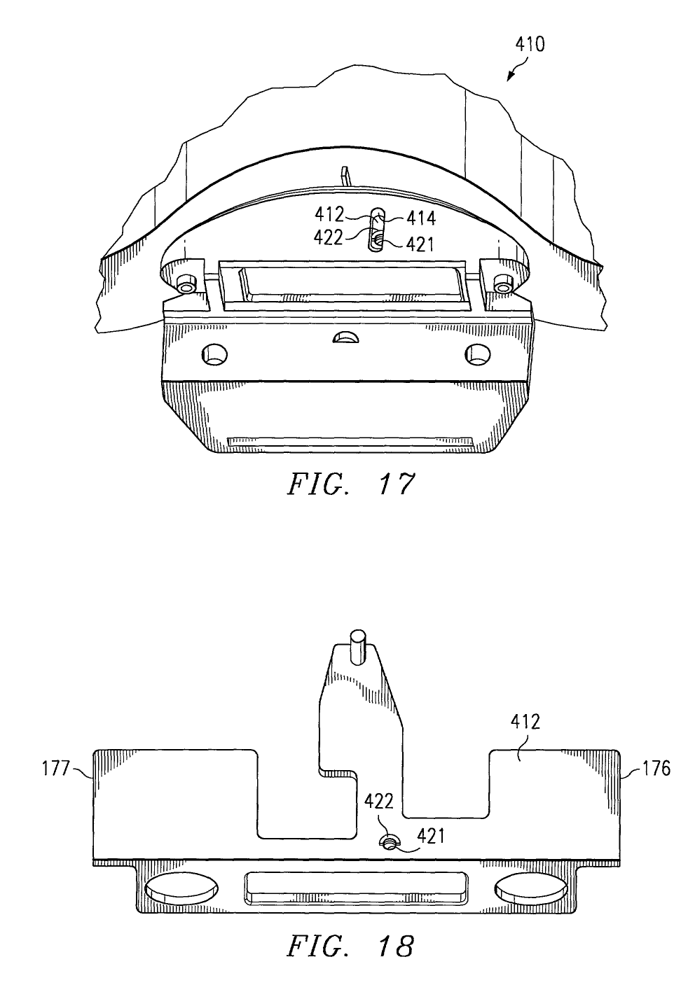

FIG. 17 is a diagrammatic fragmentary perspective rear view of a portion of a drive module 410, which is an alternative embodiment of the drive module 18 shown in FIGS. 3 and 5. FIG. 18 is a diagrammatic perspective view showing rear and bottom sides of an eject member 412 which is a component of the drive module 410 of FIG. 17, and which is an alternative embodiment of the eject member shown at 171 in FIGS. 11 and 12. The drive module 410 and eject member 412 are similar to the drive module 18 and eject member 171 described previously, except for the differences described below.

More specifically, as discussed above in association with FIGS. 8, 14 and 15, the housing of the drive module 18 has a manual release opening 261. In contrast, the drive module 410 does not have the opening 261, but instead has a vertical slot 414 provided through an approximately vertical wall of the housing that is located near the rear side of the eject member 412. In FIG. 17, the eject member 412 can be seen through the slot 414. As discussed above in association with the drive module 18, the opening 261 in that drive module is positioned so that it is accessible only when the drive module 18 is disengaged from and physically separated from the interface module 17. With reference to the drive module 410, it will be noted that the slot 414 is also positioned so that it is accessible only when the drive module 410 is disengaged from and physically separated from the interface module 17.

As shown in FIGS. 17 and 18, the eject member 412 has a cylindrical opening 421 extending horizontally through a vertical wall thereof. The opening 421 is located approximately halfway between the outer edges 176 and 177 of the eject member 412. The eject member 412 also has on the rear side thereof a rearwardly-projecting semicircular ridge 422, which is concentric to and adjacent the opening 421, and which is located on the upper side of the opening 421. As the eject member 412 moves from its retracted position to its eject position, the opening 421 in the eject member 412 moves from a position aligned with a lower portion of the slot 414 to a position aligned with an upper portion of the slot 414.

In the embodiment of FIGS. 17 and 18, a manual release is effected in the following manner. It is assumed for purposes of discussion that the drive module 410 has therein a cartridge 14 (which is not visible in FIGS. 17-18), and has been physically detached from the interface module 17 so that the slot 414 is accessible. An elongate release element (which is not illustrated but is similar to the release element shown at 291 in FIG. 8) is inserted into the slot 414 so as to engage the underside of the ridge 422 adjacent the opening 421.

Although it is sufficient if the end of the release element engages the ridge 422 but does not extend into the opening 421, it is preferable that the end of the release element extend into the opening 421.

Since the eject member 412 will be in its retracted position, the opening 421, the ridge 422 and the release element will be near the lower end of the slot 414. The release element is then moved manually upwardly within the slot 414, so that the eject member 421 is moved manually upwardly from its retracted position to its eject position. This effects a release and ejection of the cartridge in the manner described above in detail for the embodiment of FIGS. 1-15. The release element is then manually withdrawn from the slot 414. Since the opening 421 and the ridge 422 are approximately halfway between the outer edges 176 and 177 of the eject member 412, the upward force exerted manually on the eject member 412 is applied in approximately the center of the eject member 412. Accordingly, the entire eject member 412 tends to move smoothly upwardly without being urged by the applied force to rotate about some axis parallel to the axis of the opening 421.

The present invention provides a number of technical advantages. One such technical advantage is that the removable data storage cartridge is reliably and releasably locked within the drive after it is inserted, and remains locked there until an eject mechanism within the drive is actuated. A related advantage is that, when the cartridge is releasably locked within the drive, exertion of a manual withdrawal force on the cartridge has the effect of increasing the effective locking force.

According to another advantage, the eject mechanism is a motor-powered mechanism. A related advantage is that this eject mechanism is simple and involves a minimum number of parts, and is thus relatively inexpensive. A further advantage is that the motor which drives the eject mechanism rotates in only a single direction. Still another advantage is that the eject mechanism effects not only a release of the locking mechanism which releasably holds the cartridge, but also effects sufficient movement of the cartridge to achieve full disengagement of the connectors which electrically couple the cartridge and the drive.

Still another advantage is that the eject mechanism resets the releasable locking arrangement to a state in which it is ready for insertion of another cartridge. A further related advantage is that a single movable eject member is configured to effect multiple functions associated with cartridge ejection, including release of the locking mechanism, cartridge movement that disengages the connectors, and resetting of the locking mechanism so it is ready for insertion of another cartridge. Yet another advantage is the eject member can move freely when the eject mechanism is disabled, for example so that manual insertion of a cartridge is possible without any interference from the eject mechanism, and without any need to energize the eject mechanism.

Although selected embodiments have been illustrated and described in detail, it will be understood that various substitutions and alterations are possible without departing from the spirit and scope of the present invention, as defined by the following claims.

What is claimed is:

1. An apparatus comprising a receiving unit which includes:
a connector;
a locking part supported for movement between locking and unlocking positions;
a cartridge receiving portion into which a cartridge can be removably inserted to an inserted position, wherein when a cartridge is in said cartridge receiving portion, said locking part engages the cartridge in said locking position thereof to resist cartridge removal, and a connector of the cartridge is releasably coupled to said connector of said receiving unit in order to electrically couple said receiving unit to an information storage section of the cartridge;
a retaining portion which resists movement of said locking part away from said locking position when a cartridge is inserted in the cartridge receiving portion and engaged with said locking part;
an eject member supported for movement between a retracted position and an eject position, wherein as said eject member moves from said retracted position to said eject position said eject member engages and moves said locking member away from said locking position toward said unlocking position, and wherein when a cartridge is in said cartridge receiving portion as said eject member moves from said retracted position to said eject position, said eject member engages and moves the cartridge away from the insertion position in a manner effecting disengagement of said connector of said receiving unit from a connector of the cartridge; and
a drive portion responsive to the occurrence of a predetermined condition for effecting movement of said eject member from said retracted position to said eject position.

2. An apparatus according to claim 1,
wherein said retaining portion yieldably urges said locking part toward said locking position thereof;
wherein said locking part has on a side thereof facing away from said unlocking position a recess, a first cam surface that extends away from said recess on one side thereof, and a second cam surface, wherein a locking portion of a cartridge being inserted into said cartridge receiving portion slides along said first cam surface while moving said locking part away from said locking position to facilitate engagement of the locking portion with said recess in the inserted position of the cartridge; and
wherein said eject member has a cam follower portion which slidably engages said second cam surface as said eject member moves from said retracted position to said eject position in order to effect movement of said locking part away from said locking position against the urging of said retaining portion.

3. An apparatus according to claim 2,
wherein said receiving unit includes a further locking part supported for movement between locking and retracted positions;
wherein said connector of said receiving unit is disposed between said locking parts;
wherein movement of each said locking part toward said locking position thereof is movement away from the other of said locking parts;
wherein said retaining portion yieldably urges said further locking part toward said locking position thereof;
wherein said further locking part has on a side thereof facing generally away from said unlocking position thereof a further recess, a third cam surface that extends away from said further recess on one side thereof, and a fourth cam surface, wherein a further locking portion of a cartridge being inserted into said cartridge receiving portion slides along said third cam surface while moving said further locking part away from said locking position thereof to facilitate engagement of the further locking portion with said further recess in the inserted position of the cartridge; and
wherein said eject member has a further cam follower portion which slidably engages said fourth cam surface as said eject member moves from said retracted position to said eject position in order to effect movement of said further locking part away from said locking position thereof against the urging of said retaining portion.

4. An apparatus according to claim 3,
wherein said eject member has a central opening therethrough;
wherein said cam follower portions of said eject member are provided adjacent opposite sides of said central opening;
wherein said connector of said receiving unit is disposed within said central opening during at least a portion of the path of travel of said eject member between said retracted and eject positions; and
wherein said locking parts each extend through said central opening on opposite sides of said connector of said receiving unit.

5. An apparatus according to claim 3, including a cartridge which has a connector and which has locking recesses that are disposed on opposite sides of said connector and that each have a respective said locking portion therein, said cartridge being removably inserted in said cartridge receiving portion so that said connector of said cartridge is releasably engaged with said connector of said receiving unit, and so that each said locking part is engaged with said locking portion within a respective said locking recess.

6. An apparatus according to claim 2, wherein said second cam surface extends away from said recess on a side thereof opposite from said first cam surface;
wherein said cam follower portion of said eject member engages said recess in said eject position of said eject member to resist movement of said eject member away from said eject position so that said eject member maintains said locking part in a position which facilitates engagement of said locking part with a cartridge when a cartridge is subsequently inserted into said cartridge receiving portion; and
wherein at least one of said recess and said second cam surface is shaped to facilitate sliding movement of said cam follower portion out of said recess and onto said second cam surface in response to exertion of an insertion force onto said eject member by a cartridge being inserted into said cartridge receiving portion.

7. An apparatus according to claim 6,
wherein said receiving unit includes a further locking part supported for movement between locking and retracted positions;
wherein said connector of said receiving unit is disposed between said locking parts;
wherein movement of each said locking part toward said locking position thereof is movement generally away from the other of said locking parts;
wherein said retaining portion yieldably urges said further locking part toward said locking position thereof;
wherein said further locking part has on a side thereof facing away from said unlocking position thereof a further recess, a third cam surface that extends away from said further recess on one side thereof, and a fourth cam surface, wherein a further locking portion of a cartridge being inserted into said cartridge receiving portion slides along said third cam surface while moving said further locking part away from said locking position thereof to facilitate engagement of the further locking portion with said further recess in the inserted position of the cartridge;
wherein said eject member has a further cam follower portion which slidably engages said fourth cam surface as said eject member moves from said retracted position to said eject position in order to effect movement of said further locking part away from said locking position thereof against the urging of said retaining portion;
wherein said fourth cam surface extends away from said further recess on a side thereof opposite from said third cam surface;
wherein said further cam follower portion of said eject member engages said further recess in said eject position of said eject member to resist movement of said eject member away from said eject position so that said eject member maintains said further locking part in a position which facilitates engagement of said further locking part with a cartridge as a cartridge is subsequently being inserted into said cartridge receiving portion; and
wherein at least one of said further recess and said fourth cam surface is shaped to facilitate sliding movement of said further cam follower portion out of said further recess and onto said fourth cam surface in response to exertion of an insertion force onto said eject member by a cartridge being inserted into said cartridge receiving portion.

8. An apparatus according to claim 7,
wherein said eject member has a central opening therethrough;
wherein said cam follower portions of said eject member are provided adjacent opposite sides of said central opening;
wherein said connector of said receiving unit is disposed within said central opening during at least a portion of the path of travel of said eject member between said retracted and eject positions; and
wherein said locking parts each extend through said central opening on opposite sides of said connector of said receiving unit.

9. An apparatus according to claim 6, wherein said locking part has a stop surface on a side of said second cam surface remote from said recess, said stop surface engaging said eject member in said retracted position to prevent movement of said eject member past said retracted position.

10. An apparatus according to claim 9,
wherein said receiving unit includes a further locking part supported for movement between locking and retracted positions;
wherein said connector of said receiving unit is disposed between said locking parts;
wherein movement of each said locking part toward said locking position thereof is movement generally away from the other of said locking parts;
wherein said retaining portion yieldably urges said further locking part toward said locking position thereof;
wherein said further locking part has on a side thereof facing away from said unlocking position thereof a further recess, a third cam surface that extends away from said further recess on one side thereof, and a fourth cam surface, wherein a further locking portion of a cartridge being inserted into said cartridge receiving portion slides along said third cam surface while moving said further locking part away from said locking position thereof to facilitate engagement of the further locking portion with said further recess in the inserted position of the cartridge;
wherein said eject member has a further cam follower portion which slidably engages said fourth cam surface as said eject member moves from said retracted position to said eject position in order to effect movement of said further locking part away from said locking position thereof against the urging of said retaining portion;
wherein said fourth cam surface extends away from said further recess on a side thereof opposite from said third cam surface;
wherein said further cam follower portion of said eject member engages said further recess in said eject position of said eject member to resist movement of said eject member away from said eject position so that said eject member maintains said further locking part in a position which facilitates engagement of said further locking part with a cartridge when a cartridge is subsequently inserted into said cartridge receiving portion;
wherein at least one of said further recess and said fourth cam surface is shaped to facilitate sliding movement of said further cam follower portion out of said further recess and onto said fourth cam surface in response to exertion of an insertion force onto said eject member by a cartridge being inserted into said cartridge receiving portion; and
wherein said further locking member has a further stop surface on a side of said fourth cam surface remote from said further recess, said further stop surface engaging said eject member in said retracted position to prevent movement of said eject member past said retracted position.

11. An apparatus according to claim 10,
wherein said eject member has a central opening therethrough;
wherein said cam follower portions of said eject member are provided adjacent opposite sides of said central opening;
wherein said connector of said receiving unit is disposed within said central opening during at least a portion of the path of travel of said eject member between said retracted and eject positions; and
wherein said locking parts each extend through said central opening on opposite sides of said connector of said receiving unit.

12. An apparatus according to claim 11, wherein said movement of each said locking part is pivotal movement about a respective pivot axis spaced radially from said recess and said cam surfaces thereon.

13. An apparatus according to claim 12, wherein said retaining portion includes a spring element which is supported on said receiving unit and which has opposite ends that each engage a respective one of said locking parts and yieldably urge movement of said locking parts toward said locking positions thereof.

14. An apparatus according to claim 1,
wherein said eject member has a surface portion thereon which faces away from a direction in which said eject member moves toward said eject position; and
S wherein said drive portion includes a rotatable member having an actuating portion thereon which is engageable with said surface portion on said eject member in a manner so that said eject member is moved from said retracted position to said eject position by said actuating portion in response to rotation of said rotatable member by said drive portion.

15. An apparatus according to claim 14, wherein said actuating portion of said rotatable member moves out of engagement with said surface portion of said eject member in response to further rotation of said rotatable member after said eject member has reached said eject position, said eject member being movable from said eject position to said retracted position free of engagement between said surface portion thereon and said actuating portion of said rotatable member.

16. An apparatus according to claim 15,
wherein said rotatable member is normally stationary in a predetermined initial angular position;
wherein said drive portion is responsive to said predetermined condition for effecting rotation of said rotatable member; and
wherein said drive portion includes a switch which is actuated by said actuating portion after said actuating portion has moved out of engagement with said surface portion of said eject member, said drive portion being responsive to actuation of said switch for stopping said rotation of said rotatable member.

17. An apparatus according to claim 15,
wherein said rotatable member is normally stationary in a predetermined initial angular position; and
wherein said drive portion is responsive to said predetermined condition for effecting a single 360° rotation of said rotatable member which begins and ends with said rotatable member in said initial angular position.

18. An apparatus according to claim 17,
wherein said rotatable member has gear teeth thereon;
wherein said actuating portion is a pin on said actuating member which is positioned eccentrically to an axis of rotation thereof; and
wherein said drive portion includes a motor having a rotatable shaft, and a gear train which drivingly couples said shaft of said motor to said gear teeth of said rotatable member.

19. An apparatus according to claim 1,
wherein said drive portion includes a motor having a rotatable shaft; and
wherein all operational movement of said shaft involves rotation of said shaft in a single rotational direction.

20. An apparatus according to claim 1, wherein said locking part is configured so that said locking part will be urged toward said locking position thereof when said eject member is in said retracted position and a force is exerted on said locking member by a cartridge engaged therewith in a direction corresponding to cartridge withdrawal.

21. An apparatus according to claim 20,
including a further locking part supported for movement between locking and unlocking positions;
wherein when a cartridge is removably inserted into said cartridge receiving portion to an inserted position said further locking part is engageable therewith when said further locking part is in said locking position thereof, said retaining portion resisting movement of said further locking part away from said locking position thereof when said locking part is releasably engaged with a cartridge;
wherein said eject member engages and moves said further locking part away from said locking position thereof toward said unlocking position thereof during movement of said eject member from said retracted position to said eject position; and
wherein said further locking part is configured so that said further locking part will be urged toward said locking position thereof if said eject member is in said retracted position and if a force is exerted on said further locking member by a cartridge engaged therewith in a direction corresponding to cartridge withdrawal.

22. An apparatus according to claim 21, wherein said movement of each of said locking parts is pivotal movement about a respective pivot axis.

23. A method of operating an apparatus which includes a receiving unit having a connector and having a cartridge receiving portion into which a cartridge can be removably inserted to an inserted position, comprising the steps of:
supporting a locking part for movement between locking and unlocking positions;
causing the locking part, when a cartridge is disposed in said cartridge receiving portion, to engage the cartridge in said locking position thereof to resist cartridge removal from a position in which a connector of the cartridge is engaged with said connector of said receiving unit to electrically couple said receiving unit to an information storage section of the cartridge;
resisting movement of said locking part away from said locking position with a retaining portion when a cartridge is disposed in the cartridge receiving portion and engaged with said locking part;
supporting an eject member for movement between a retracted position and an eject position;
causing said eject member to move said locking member away from said locking position toward said unlocking position during movement of said eject member from said retracted position to said eject position;
causing said eject member, when a cartridge is disposed in said cartridge receiving portion, to engage and move the cartridge away from its insertion position as said eject member moves from said retracted position to said eject position, in a manner effecting disengagement of said connector of said receiving unit from a connector of the cartridge; and
responding to the occurrence of a predetermined event by causing a drive portion to effect movement of said eject member from said retracted position to said eject position.

24. A method according to claim 23,
wherein said step of resisting movement with said retaining portion includes the step of yieldably urging said locking part toward said locking position thereof; and
including the steps of:
configuring said locking part to have, on a side thereof facing away from said unlocking position, a recess, a first cam surface that extends away from said recess on one side thereof, and a second cam surface;
causing a locking portion of a cartridge being inserted into said cartridge receiving portion to slide along said first cam surface while moving said locking part away from said locking position to facilitate engagement of the locking portion with said recess in the inserted position of the cartridge; and
causing a cam follower portion on said eject member to slidably engage said second cam surface as said eject member moves from said retracted position to said eject position in order to effect movement of said locking part away from said locking position against the urging of said retaining portion.

25. A method according to claim 24, including the steps of:
configuring said locking part so that said second cam surface extends away from said recess on a side thereof opposite from said first cam surface;
causing said cam follower portion of said eject member to engage said recess in said eject position of said eject member to resist movement of said eject member away from said eject position so that said eject member maintains said locking part in a position which facilitates engagement of said locking part with a cartridge as a cartridge is subsequently being inserted into said cartridge receiving portion; and
configuring said locking part so that at least one of said recess and said second cam surface is shaped to facilitate sliding movement of said cam follower portion out of said recess and onto said second cam surface in response to exertion of an insertion force onto said eject member by a cartridge being inserted into said cartridge receiving portion.

26. A method according to claim 25, including the steps of:
supporting a further locking part for movement between locking and retracted positions so that said connector of said receiving unit is disposed between said locking parts, and so that movement of each said locking part toward said locking position thereof is movement generally away from the other of said locking parts;
causing said retaining portion to yieldably urge said further locking part toward said locking position thereof;
configuring said further locking part to have on a side thereof facing away from said unlocking position thereof a further recess, a third cam surface that extends away from said further recess on one side thereof, and a fourth cam surface;
causing a further locking portion of a cartridge being inserted into said cartridge receiving portion to slide along said third cam surface while moving said further locking part away from said locking position thereof to facilitate engagement of the further locking portion with said further recess in the inserted position of the cartridge;
causing a further cam follower portion of said eject member to slidably engage said fourth cam surface as said eject member moves from said retracted position to said eject position in order to effect movement of said further locking part away from said locking position thereof against the urging of said retaining portion;
configuring said fourth cam surface to extend away from said further recess on a side thereof opposite from said third cam surface;
causing said further cam follower portion of said eject member to engage said further recess in said eject position of said eject member to resist movement of said eject member away from said eject position so that said eject member maintains said further locking part in a position which facilitates engagement of said further locking part with a cartridge when a cartridge is subsequently inserted into said cartridge receiving portion; and
configuring said further locking member so that at least one of said further recess and said fourth cam surface is shaped to facilitate sliding movement of said further cam follower portion out of said further recess and onto said fourth cam surface in response to exertion of an insertion force onto said eject member by a cartridge being inserted into said cartridge receiving portion.

27. A method according to claim 26, including the step of providing a central opening through said eject member with said cam follower portions of said eject member adjacent opposite sides of said central opening, said connector of said receiving unit being disposed within said central opening during at least a portion of the path of travel of said eject member between said retracted and eject positions, and said locking parts each extending through said central opening on opposite sides of said connector of said receiving unit.

28. A method according to claim 23, including the steps of:
providing on said eject member a surface portion which faces away from a direction in which said eject member moves toward said eject position; and
supporting a rotatable member of said drive portion for rotation and providing thereon an actuating portion which is engageable with said surface portion on said eject member in a manner so that said eject member is moved from said retracted position to said eject position by said actuating portion in response to rotation of said rotatable member by said drive portion.

29. A method according to claim 28, including the step of causing said actuating portion of said rotatable member to move out of engagement with said surface portion of said eject member in response to further rotation of said rotatable member after said eject member has reached said eject position, said eject member being movable from said eject position to said retracted position free of engagement between said surface portion thereon and said actuating portion of said rotatable member.

30. A method according to claim 29, including the steps of:
normally maintaining said rotatable member stationary in a predetermined initial angular position;
responding to said predetermined condition by effecting rotation of said rotatable member;
causing said actuating portion to actuate a switch after said actuating portion has moved out of engagement with said surface portion of said eject member; and
responding to actuation of said switch by stopping said rotation of said rotatable member.

31. A method according to claim 29,
wherein said rotatable member is normally stationary in a predetermined initial angular position; and
including the step of responding to said predetermined condition by effecting a single 360° rotation of said rotatable member which begins and ends with said rotatable member in said initial angular position.

32. A method according to claim 23, including the step of configuring said locking part so that said locking part will be urged toward said locking position thereof when said eject member is in said retracted position and a force is exerted on said locking part by a cartridge engaged therewith in a direction corresponding to cartridge withdrawal.
